(19) United States
(12) Patent Application Publication
(10) Pub. No.: US 2003/0046683 A1
(43) Pub. Date: Mar. 6, 2003

(54) Server-side preference prediction based on customer billing information to generate a broadcast schedule

(76) Inventor: Curtis E. Jutzi, Lake Oswego, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/941,424

(22) Filed: Aug. 28, 2001

(51) Int. Cl. H04N 7/16

(52) U.S. Cl. 725/2; 725/1

(57) ABSTRACT

For each of the customers of a broadcast service, server software can predict the content that the customer's client software is expected to acquire from the servers on behalf of the customer. This is based on (1) billing information for the customer received from the customer's client software and that describes previously broadcast content acquired by the client software on behalf of the customer, and (2) a description of available content that will be available for broadcast by the service and that can be acquired by the customer's client software. One application includes deriving a broadcast schedule for the service based on such predicted content for the customers.

### BACKGROUND

Modern television broadcast services use either guided transmissions (e.g. via cable) or unguided transmissions (e.g. via terrestrial and satellite antennas) to provide their customers with a wide range of content. The content may include motion picture films, national television shows, music and music videos. In the future, this list may be expected to include additional content such as computer games and digital literature such as digital books. The broadcast services typically provide different channels each being used to deliver a certain kind of content to the customers. In one type of broadcast system, the same movie is broadcast on multiple channels but at staggered time intervals. If a customer wants to watch that movie ‘on demand’, then she can tune into the appropriate channel and then wait a short period of time for the movie to start on that channel. Of course, the more channels are used to broadcast the same movie, the shorter the period of time the customer will have to wait for the movie to start.

In another type of broadcast system, the customer has a digital video recorder which may be part of a ‘set top box’ (i.e. STB) that is coupled to the customer's television receiver. The recorder can be programmed by the customer to pre-record any desired broadcast content that can be received by the receiver. Once recorded, the programs are available for the customer to play them back on demand.

Due to the limited bandwidth available in the channels of a broadcast system, the channels should be used efficiently to increase the amount of content that will actually be demanded and ‘consumed’ by the customer. One way to do so is to tailor the broadcast schedule according to what is preferred by the customers. For example, many of today's television broadcasters rely upon program ratings to determine their future programming and broadcast schedules. These ratings estimate the number of viewers of a television program based upon a survey of a small sample of viewers in the general public. This technique, however, may be very inconvenient because it involves delivering a survey form to or calling a number of viewers to get their responses.

### BRIEF DESCRIPTION OF THE DRAWINGS

FIG. 1 depicts a block diagram of a broadcast environment.

FIG. 2 shows a block diagram of the interaction between a client and a server in the broadcast environment, according to an embodiment of the preference prediction process.

FIG. 3 illustrates an exemplary set of vectors that describe a movie package.

FIG. 4 depicts an exemplary billing log that contains customer billing information to be used by an embodiment of the preference prediction process.

FIG. 5 shows a flow diagram of an embodiment of the relevance algorithm used in the preference prediction process.

FIG. 6 illustrates a flow diagram of an embodiment of the voting algorithm used in the preference prediction process.

FIG. 7 depicts an exemplary broadcast schedule.

### DETAILED DESCRIPTION

A method for supporting a broadcast service is described in which the consumption preferences of the service's customers are predicted server-side, based on customer billing information. These preferences are determined without resorting to sending surveys to customers. In addition, the method does not require the customer's set top box to transmit the personal profile of the customer, thereby reducing the likelihood of a privacy concern being raised by the customer. Also, performing the method server-side reduces the computational load on the set top box, thereby potentially lowering the cost of the box. Applications of the method include the evaluation of proposed content to determine its likelihood of acceptance by the customers, and the generation of a broadcast schedule.

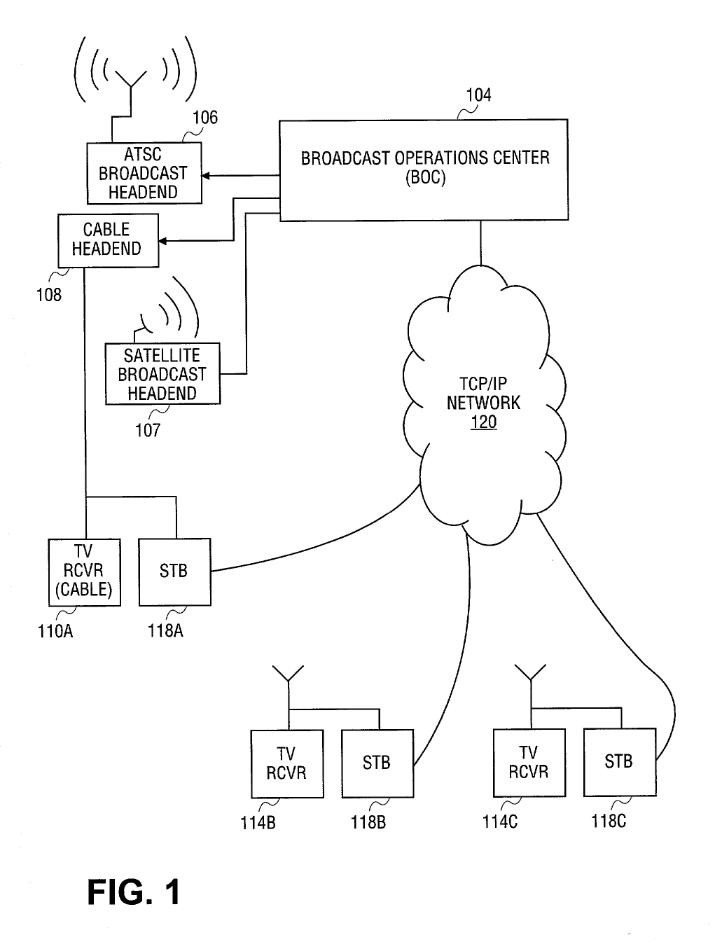

FIG. 1 depicts a block diagram of a broadcast environment. The content to be broadcast, which may also be referred to as a package such as a movie or a music video, is provided by a content provider (not shown) to a broadcast operations center (i.e., BOC) 104. The package may be provided in an analog or digital format. If in an analog format, the package may be converted into digital format by the BOC 104. The package may be a movie, short, raw data, voice, audio, video, graphics, programs, games, or a combination of these or other similar types of data. The package may of course be in a wide range of different formats. For instance, if the package is a movie, it may be provided in a motion picture experts group (i.e. MPEG) format.

The BOC 104 includes a server computer or a group of computers that are running server software designed to communicate with client software via, for example, the transport control protocol/internet protocol (i.e. TCP/IP). In addition, the BOC 104 may be used to instruct an Advanced Television Systems Committee (ATSC) broadcast head-end 106, satellite broadcast head-end 107 or a cable head-end 108 to broadcast certain packages according to a certain schedule. Instances of the client software are being executed by each set top box 118a, 118b . . . . The STB 118 acts as a control interface to its cable TV receiver 110 or antenna TV receiver 114 which receives and decodes broadcast transmissions of the content, from the points of transmission 106-108. Examples of the STB include the equipment provided by TiVo, Inc. of Alviso, Calif. or Replay TV, Inc. of Mountain View, Calif., as well as set tops from General Instruments Inc. or Scientific Atlanta Corp. As recognized by those of ordinary skill in the art, the server and client software are provided in the form of instructions stored in a machine-readable medium such as solid state memory, magnetic rotating disk drive, or an optical disk all of which can be accessed by a processor for execution. When executed, these instructions cause an electronic system, be it the BOC 104 or the STB 118, to support a broadcast service as described below.

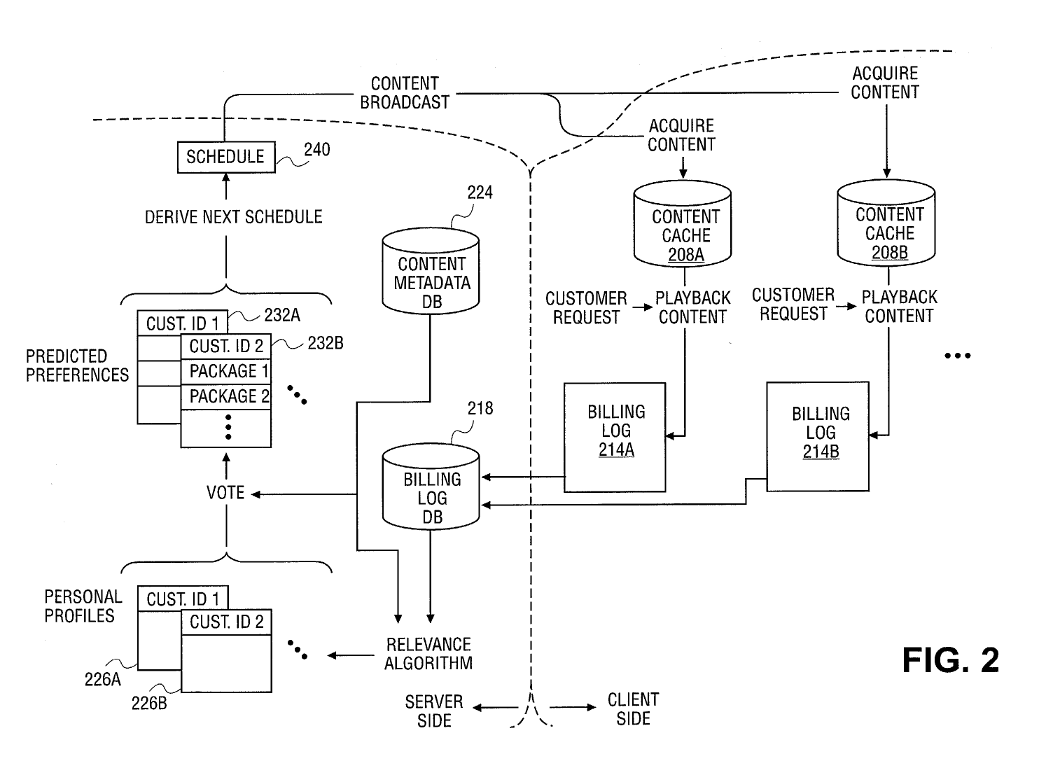

Referring now to FIG. 2, a block diagram of the interaction between a client and a server in the broadcast environment, according to an embodiment of the preference prediction process, is shown. Referring first to the client side for each customer, the broadcast content is selectively acquired, i.e. certain broadcast packages are selected to be recorded while others are not, and stored in a content cache 208. Thus, after the client software has become aware of a future broadcast schedule, a content acquisition routine may then automatically select one or more packages (content) to be acquired and stored at the time of their broadcast. The content acquisition routine may be written to perform, for instance, according to the process described in U.S. patent application Ser. No. 09/823,421 filed on Mar. 29, 2001 entitled “System and Method for Transparently Obtaining Consumer Preferences for Products and Product Features and Product Marketing” and assigned to the same assignee as that of the present application. As an alternative, the customer can tune in at the time the package is being broadcast.

After certain content has been acquired by the client software and stored in the content cache 208, the customer can then request that a particular cached package be played back on the customer's TV receiver that is associated with the STB 118 running the client software. As a package is played back, the software keeps track of how much of the package has been consumed. For instance, if the package is a movie, the playback is monitored to determine how much of the movie is actually played back. As an alternative, if the package were a music album, then the software could be designed to detect which songs of the album were and which songs were not played back. As yet another alternative, if the package includes a computer game, then different aspects of the computer game such as different levels of difficulty or optional game characters selected by the customer could be monitored as well. This monitored information may be used for billing purposes by the broadcast service, to determine how much to bill the customer for having consumed a portion or all of the package. The information may be made a part of a billing log 214. The client side software then causes the billing log 214 to be sent to the server (which, in the embodiment of FIG. 1, is a part of the BOC 104). The generation and transmission of the billing log 214 may be performed in a periodic manner, for instance every day or every week, or as often as needed to report the customer's consumption.

Turning now to the server side, billing logs 214 received from a number of client software applications (corresponding to an equal number of customers) are received and may be stored in a billing log database 218. The server side may also contain a content metadata database 224 which stores descriptions of packages that are available for broadcast, whether previously broadcast or not. These descriptions, which may also be referred to as “vectors”, are used in a preference prediction process to determine, by server software, predicted content that the customer's client software is expected to acquire from the broadcast content on behalf of the customer. This prediction process is based on (1) billing information for the customer received from the customer's client software and that describes previously broadcast content acquired by the client software on behalf of the customer, and (2) a description of available content that will be available for broadcast by the service and that can be acquired by the customer's client software. The predicted content is shown in FIG. 2 as predicted preferences 232a and 232b for two different customers. Each predicted preference 232 may be a data structure that stores a number of package identifiers. These package identifiers may be, for instance, the names of the movies which are predicted to be preferred by the customer. The identified packages may alternatively be musical albums or other types of content as was discussed above.

According to an application of the server side preference prediction process described herein, a broadcast schedule 240 may be derived for the service based on the predicted preferences 232 for the customers (see FIG. 2). In another embodiment, the prediction process generates a personal profile 226a, 226b . . . for each customer as an intermediate step of the process. These personal profiles 226 may be used to evaluate the expected popularity of a movie that has yet to be released by a movie studio.

For an embodiment of the prediction process, it is desired to replicate the content selection algorithm as it is performed by the client (to determine the content to be acquired) on the server (also referred to as the backend) using billing information delivered to the server from each client. This may be achieved using, for example, a vector-based relevance algorithm implemented at the backend (see FIG. 2). If the algorithm were being performed at the client (to determine which packages to acquire), an input to the algorithm would be a customer supplied rating (e.g., on the scale +10 to −10) for each package that has been ‘consumed’ by the customer. According to an embodiment of prediction process, to perform the algorithm at the backend, this rating information may be derived from the customer's billing information received from the client software. Briefly, as an example, if the billing information indicates that all of the package was consumed, then the package could be given a +8 rating at the backend. On the other hand, if only a small portion was consumed, then a −8 rating could be assigned. Further details of the algorithm are given below.

An output of the relevance algorithm may be a personal profile of the customer. This output may then be fed to a voting algorithm (see FIG. 2). The voting algorithm will serve to evaluate an available package, based on the personal profile of the customer, to determine whether the package would be preferred by the customer. A list that contains the most preferred packages for the customer (a predicted preference 232) is thus compiled.

An Embodiment of the Relevance Algorithm

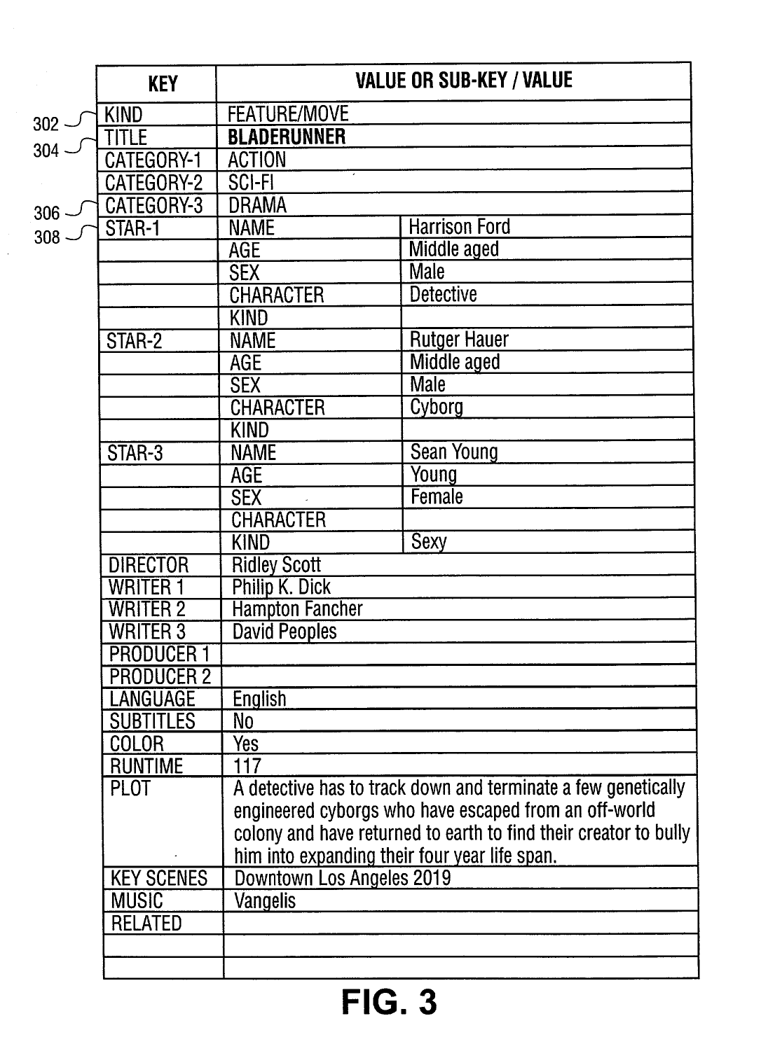

The relevance algorithm can be applied to determine which of several vectors that describe a package are the most relevant for predicting a customer's package preference. Each vector in this case is defined by a unique Key and Value pair. In the case of the movie embodiment, Key and Value pairs suitable for predicting a customer's movie preference might include, for example: Vector_director_directorname, Vector_star_starname, and Vector_category_categoryname. Each package may be assigned a number of vectors, including those that identify factors used by customers or by a content acquisition routine to help make decisions when demanding the packages. For example, FIG. 3 shows a list of vectors that include vectors 302, 304, 306, and 308, each identified by a unique Key and Value pair, that could be assigned to the movie ‘Blade Runner’ and that perhaps would be useful in predicting that customer's movie preferences.

Each package may be rated according to a customer preference level (CPL) that may range, for instance, from −10 to +10. A package with a more positive CPL indicates that the customer would prefer it over one that has a less positive CPL. A negative CPL could indicate that the package would not be preferred by the customer.

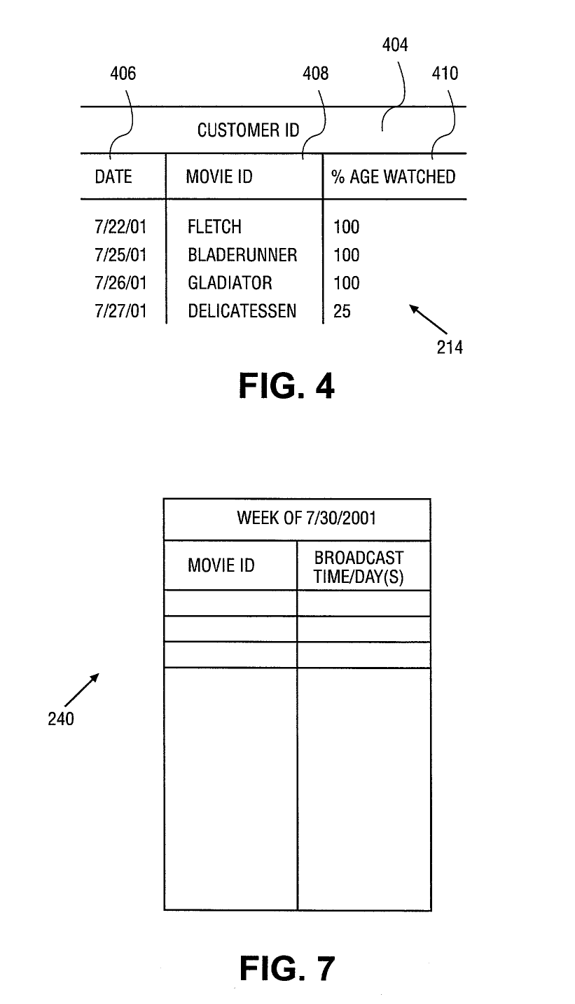

According to an embodiment of the invention, the CPL of a particular customer for a given package is derived directly from the billing information received for that customer. This billing information may be gleaned from the billing log 214 (see FIG. 2) which itself may be routinely generated by the client software and transmitted to the server. FIG. 4 shows an exemplary billing log 214.

The billing log 214 in FIG. 4 contains a customer ID field 404 that identifies the customer by name and/or account number. In this embodiment, there are three columns of billing information for the customer: a date field 406 that shows when an acquired package was consumed, a package ID field 408 that contains an identifier for the consumed package, and a percentage consumed field 410 that shows what portion of the acquired package was actually consumed. Thus, in the example shown, the customer's billing information indicates that only a small portion (actually 25%) of the acquired movie ‘Delicatessen’ was actually played back, while the other three acquired movies were played back in their entireties. Such billing information may be stored in a billing log database, and processed by the relevance algorithm to assign a customer-specific CPL value to each demanded package. This may be explained using the following example for movies.

A CPL is assigned to some or all of the vectors present in an acquired movie, based on what percentage of the movie was played back (as reported in a billing log). Thus, if the movie was acquired but only partially played back, the CPL for this instance of the movie could be a −negative value, e.g. −3 (i.e., we assume the movie was not a preferred movie). On the other hand, if the movie was played back in its entirety, the CPL could be +5. If the movie was played back again in its entirety, the CPL could be +7 (i.e. we assume the movie was well liked).

If a recently broadcast movie was not acquired on behalf of the customer, i.e. the movie does not appear in any billing log received for the customer, then, according to an embodiment, no CPL would be determined for the movie at that time. On the other hand, if the movie had been broadcast many times but was never acquired by the customer, a CPL of −5 (i.e. not preferred) could then be assigned. Other methodologies for determining a CPL value that is associated with some or all of the vectors present in a given package, based on a customer's billing information and based on previous broadcast schedules, are possible.

Returning to the definition of a vector, in addition to the Key and Value pair, the vector may include additional dimensions that may be used in the relevance algorithm. The additional dimensions of a vector may be, for instance:

Preference Magnitude (i.e., Pmag)=the average of a number of CPL values for this particular vector, where each CPL value may be associated with a different package that was demanded on behalf of the same customer;

Standard Deviation (i.e., SD) of Pmag=the standard deviation of the collected CPL values for this vector; and

Reference Count (i.e., Rmag)=the number of times this vector was present with a package when a CPL value was determined for that package.

Thus, a collection of vectors may be associated with each package and stored in a database. Some of these vectors may appear with many of the packages while others appear less frequently. For instance, vector_Language_English appears with every English language movie, while vector_Category6_DetectiveMystery will appear much less frequently with a movie than vector_Category3_Drama.

A goal of the relevance algorithm is to determine which vectors are most valuable for predicting the preferences of a customer. These may be referred to as the predictive vectors or the “top 10” vectors of the customer's personal profile 226 (see FIG. 1). Of course, the number 10 used here is merely for illustration purposes and not intended to be a true limit on the number of predictive vectors. These “top 10” vectors may then be compared to the vectors of the available packages, so that a “top 10” list of packages for the customer can be selected. The latter may be performed by a voting algorithm described further below. As to determining which vectors are most valuable, an example of such a process now follows.

A vector may be selected to be in the “top 10” for a customer, based on the results of two sub-processes. According to an embodiment, the first sub-process filters out any vectors that have a relatively small Rmag as compared to the total number of instances of a CPL being generated for that customer. This means that those vectors are statistically insignificant compared to how often a CPL has been assigned to a package, for that customer. It is also assumed here that such vectors are not good predictors for that customer. For instance, vector_Star_Curtjutzi might appear twice in 1000 movies, and as such could be filtered out by being removed from the database or eliminated at the point where vectors are being applied by the relevance algorithm.

However, even if a vector has been filtered out, that vector could reappear in the future if the vector were present with a package for which a CPL is later determined for that customer. According to an embodiment, the Rmag of such a “new” vector would start with 1, i.e. the value of Rmag in an earlier, filtered version of the vector would be ignored.

In the second sub-process of this embodiment, the vectors that remain following the first sub-process are further analyzed for their SD values. According to an embodiment, those vectors that have relatively large SD values are filtered out. This is based on the assumption that the ability of such a vector to accurately predict the preference of a customer is not as good as that of a vector having a small SD value.

Application of the above-described two sub-processes will yield vectors that have a significant number of references (large Rmag) as well as low standard deviation (small SD). These vectors can then be sorted, from the one having the largest Rmag and smallest SD to the one having the smallest Rmag and largest SD. The “top 10” vectors are then picked from this sorted list and become part of the customer's personal profile (see FIG. 1). It is believed that these predictive vectors should exhibit a high probability of accurately predicting the customer's preference. In addition, as described further below, the collected predictive vectors from a large number of customers may be used to predict the popularity of a future package that is not yet available for broadcast.

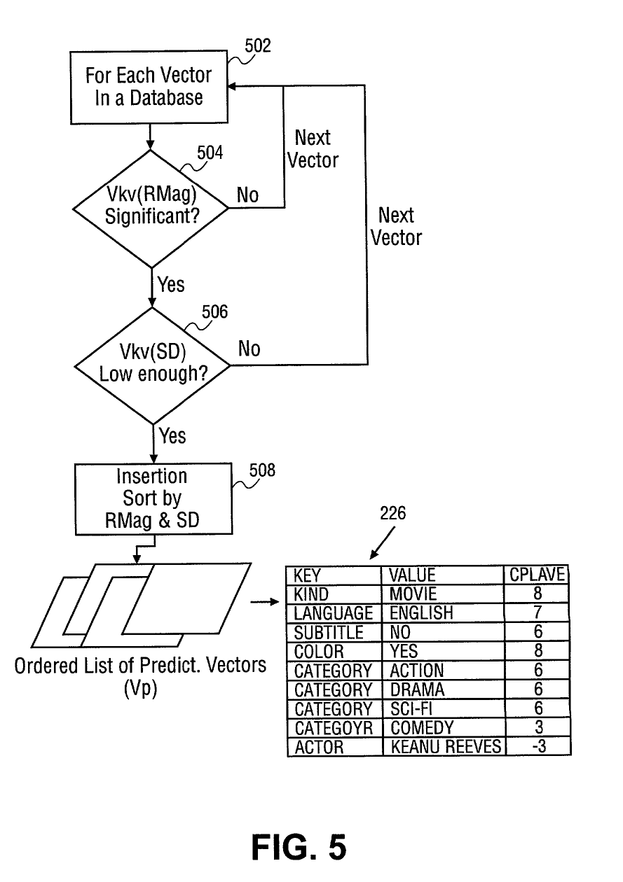

FIG. 5 illustrates a flow diagram that summarizes an embodiment of the above-described relevance algorithm. The operations may be performed entirely at the server side (see FIG. 1). Briefly, operation may begin with selecting a vector V_{k,v} from a database (block 502), and determining whether that vector has a significant Rmag (block 504). If not, the vector is filtered out. According to an embodiment, a filtered out vector will not re-appear in block 502 until it is present when a package is assigned a CPL, at a later time. Operation proceeds with block 506 in which the standard deviation (i.e., SD) of the vector is tested. If the SD is low enough, then the vector is added to the “top 10” list of predictive vectors Vₚ which is sorted according to their relative Rmag and SD values (block 508). Otherwise, the vector is filtered out. The ordered list of predictive vectors Vₚ makes its way into the customer profile 226, an example of which is shown in FIG. 5.

In some situations, a vector that does not appear very often (i.e., it has a relatively small Rmag) may nonetheless be a good predictor and should therefore not be filtered out. For example, consider a vector that has almost always generated a predicted CPL of −10, i.e., least preferred rating, for certain available packages. If this prediction turns out to be valid as tested (by, for instance, broadcasting the −10 rated packages and noting no acquisitions for them by the clients), then the vector is a good predictor despite its low Rmag.

An Embodiment of the Voting Algorithm

According to an embodiment, the package prediction process continues with a voting algorithm which uses the predictive vectors Vₚ (described in connection with FIG. 5 above) to identify the customer's predicted preference 232 (see FIG. 1.) This predicted preference 232 includes a list of available packages that should be preferred by the customer. For the movie embodiment, this list may not contain any previously broadcast and preferred (i.e., positive CPL) movies, the rationale being that once such a movie has been watched in its entirety, the customer will probably not want to watch it again until a fairly long time later. This reasoning, however, may not apply to every type of package, e.g. computer games.

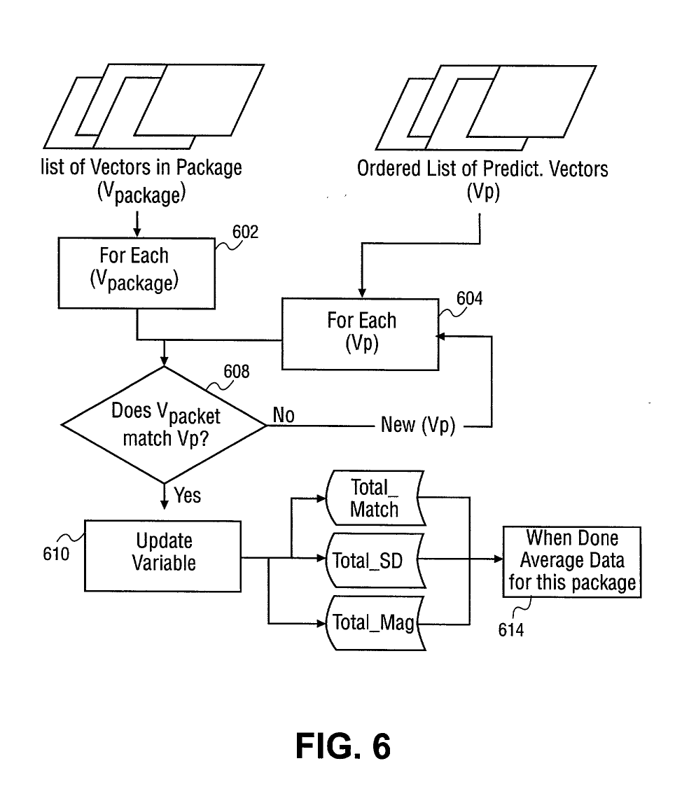

FIG. 6 depicts a flow diagram of an embodiment of the voting algorithm. An available package is selected from the database and one of its vectors V_{package} is retrieved (block 602). Thus, if the movie ‘Blade Runner’ were selected, its list of package vectors could be as shown in FIG. 3. In addition, a predictive vector Vₚ from the customer's ordered list of predictive vectors is also retrieved (operation 604). Whenever the retrieved package vector V_{package} matches a predictive vector Vₚ (operation 608), a Total_Match variable is incremented, the SD of the matching predictive vector is added to a Total_SD variable, and the Pmag of the matching predictive vector is added to a Total_Mag variable (operation 610). These running totals for the package are complete when all of the package vectors have been compared to all of the customer's predictive vectors. Thereafter, an average SD (e.g. divide Total_SD by Total_Match) and an average Pmag (e.g. divide Total_Mag by Total_Match) is computed for the package (operation 614). The average Pmag indicates the predicted CPL of that package, while the average SD represents a level of confidence in the prediction. The voting algorithm described above is applied to a number of available packages, yielding a predicted UPL and confidence for each such package. These predicted UPLs and confidence levels are then sorted and ranked, to give a “top 10” list of predicted package preference 232 for the customer.

Once the prediction process, including the relevance and voting algorithms described above, have been applied to the data stored for each customer of the broadcast service, a broadcast schedule may be determined as follows. Starting with the predicted package preferences 232a, 232b, . . . as seen in FIG. 1, for each such package its predicted CPLs, across all or a desired subset of the customers of the broadcast service, are summed. The “top 10” of these sums may then be selected as the packages to be broadcast in a future time interval. An exemplary movie broadcast schedule that may be derived by such a process is shown in FIG. 7. The manner in which the broadcast time and day of each “top 10” movie is determined may be entirely conventional.

There are a wide range of variations to the above-described process for determining the broadcast schedule. For instance, in addition to the average Pmag or CPL values, the average standard deviation (SD) values of the predicted packages (see FIG. 6) may also be used to determine the “top 10” packages for broadcast. Also, the above-described processes of the relevance algorithm, the voting algorithm, as well as the broadcast schedule determination may be combined with other automated processes that yield future programming information for broadcast services. In practice, the relevance and voting algorithms may be applied each time new billing information is received from the client software, to routinely update the personal profiles 226 and predicted preferences 232 of the customers. In this manner, a database could at all times contain the most recent personal profiles and predicted preferences of the service's customers.

To summarize, various embodiments of a server-side package preference prediction process have been described. In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative rather than a restrictive sense.

What is claimed is:

1. A method for supporting a broadcast service, comprising:
for each of a plurality of customers of the broadcast service, determining, by executing server software, predicted content that the customer's client software is expected to acquire from the service on behalf of the customer, based on (1) billing information for the customer received from the customer's client software and that describes previously broadcast content acquired by the client software on behalf of the customer, and (2) a description of available content that will be available for broadcast by the service and that can be acquired by the plurality of customers' client software; and
deriving a broadcast schedule for the service based on the predicted content for the plurality of customers, wherein the schedule includes a description of some of the available content.

2. The method of claim 1 wherein the available content includes digital movies that can be watched by the customers.

3. The method of claim 1 wherein the available content includes digital audio recordings that can be listened to by the customers.

4. The method of claim 2 wherein the billing information is taken from one or more billing logs received from the customer's client software and that identify the customer, the previously broadcast movies acquired by the client software on behalf of the customer, and the fraction of each acquired movie that was actually played back as determined by the client software.

5. The method of claim 2 wherein the predicted content for each customer is determined by performing an algorithm in the server software that computes the relevance of one or more categories in which a movie can be placed to what the client software can acquire from the service on behalf of the customer, based on a description of the previously broadcast content identified in the billing information and that includes the one or more categories for each previously broadcast movie.

6. The method of claim 5 wherein the predicted content for each customer is determined by further performing an algorithm in the server software that selects from among the available content a predicted movie whose one or more categories match the most relevant categories that were computed on behalf of the customer.

7. An article of manufacture comprising:
a machine-readable medium having a plurality of instructions stored therein which when executed by a processor cause an electronic system to support a broadcast service by determining, for each of a plurality of customers of the broadcast service, predicted content that the customer's client software is expected to acquire from the service on behalf of the customer, based on (1) billing information for the customer received from the customer's client software and that describes previously broadcast content acquired by the client software on behalf of the customer, and (2) a description of available content that will be available for broadcast by the service and that can be acquired by the plurality of customers' client software, and by deriving a broadcast schedule for the service based on the predicted content for the plurality of customers, wherein the schedule includes a description of some of the available content.

8. The article of manufacture of claim 7 wherein the available content includes digital movies that can be watched by the customers.

9. The article of manufacture of claim 7 wherein the available content includes digital audio recordings that can be listened to by the customers.

10. The article of manufacture of claim 8 wherein the billing information is to be taken from one or more billing logs received from the customer's client software and that identify the customer, the previously broadcast movies acquired by the client software on behalf of the customer, and the fraction of each demanded movie that was actually played back as determined by the client software.

11. The article of manufacture of claim 8 wherein the predicted content for each customer can be determined by performing an algorithm that computes the relevance of one or more categories in which a movie can be placed to what the client software can acquire from the service on behalf of the customer, based on a description of the previously broadcast content identified in the billing information and that includes the one or more categories for each previously broadcast movie.

12. The article of manufacture of claim 11 wherein the predicted content for each customer can be determined by further performing an algorithm that selects from among the available content a predicted movie whose one or more categories match the most relevant categories that were computed on behalf of the customer.

13. A system for supporting a broadcast service, comprising:
a server to determine, for each of a plurality of customers of the broadcast service, predicted content that the customer's client software is expected to acquire from the service on behalf of the customer, based on (1) billing information for the customer received from the customer's client software and that describes previously broadcast content acquired by the client software on behalf of the customer, and (2) a description of available content that will be available for broadcast by the service and that can be acquired by the plurality of customers' client software, the server to derive a broadcast schedule for the service based on the predicted content for the plurality of customers, wherein the schedule includes a description of some of the available content.

14. The system of claim 13 wherein the available content includes digital movies that can be watched by the customers.

15. The system of claim 13 wherein the available content includes digital audio recordings that can be listened to by the customers.

16. The system of claim 14 wherein the billing information is to be taken from one or more billing logs received from the customer's client software and that identify the customer, the previously broadcast movies acquired by the client software on behalf of the customer, and the fraction of each demanded movie that was actually played back as determined by the client software.

17. The system of claim 14 wherein the server is to further perform an algorithm that computes the relevance of one or more categories in which a movie can be placed to what the client software can acquire from the service on behalf of the customer, based on a description of the previously broadcast content identified in the billing information and that includes the one or more categories for each previously broadcast movie.

18. The system of claim 17 wherein the server is to further perform an algorithm that selects from among the available content a predicted movie whose one or more categories match the most relevant categories that were computed on behalf of the customer.
